(19) United States
(12) Patent Application Publication
(10) Pub. No.: US 2006/0180635 A1
(43) Pub. Date: Aug. 17, 2006

(54) Bonding tool and method

(76) Inventors: Oon-Pin Lim, Penang (MY); Cheng-ee Oo, Penang (MY); Jokhairi Yusoff, Penang (MY); Kin-Mun Lo, Perak (MY)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/061,707

(22) Filed: Feb. 17, 2005

(51) Int. Cl. B23K 37/00; B23K 1/06

(52) U.S. Cl. 228/1.1; 228/110.1

(57) ABSTRACT

An improved bonding tool for bonding a ribbon characterized by a thickness to a bonding pad and the method for using the same is disclosed. The bonding tool includes a transducer and a bond foot having a plurality of protrusions extending therefrom for pressing the ribbon against the bonding pad, the protrusions having a height greater than 40 percent of the ribbon thickness. The bond foot to moves with respect to the bond pad while the bond foot is pressed against the ribbon. In one embodiment, the height of the protrusions is between 40 and 80 percent of the thickness of the ribbon. In one embodiment, the protrusions include truncated pyramids having rectangular cross-sections In one embodiment, the transducer causes said bond foot to move back and forth in a predetermined direction and said protrusions are aligned such that two sides of said protrusions are perpendicular to said predetermined direction.

### BACKGROUND OF THE INVENTION

Systems involving more than one chip are constructed by connecting the chips using some form of interconnect material. In high-frequency circuits, the chips are connected by means of conductors that are adapted to have low impedance at the frequencies in question. Consider two dies that include circuitry that is to be connected by an interconnect lead. Each chip has a bond pad that provides the connection point between that chip and the interconnect lead. The interconnect lead is bonded to the bond pad in each chip. In conventional circuitry, the interconnect lead is typically a gold wire that connects the pad to another chip in the package or a lead that makes connections via traces on a printed circuit board. However, in high frequency circuitry, the chips are often connected together within a package via a gold ribbon to reduce the impedance of the interconnect at the high operating frequencies. Ribbons typically have less inductance and skin effect losses, and hence, are the preferred interconnect medium.

A typical gold bonding ribbon is normally 1.0 mil thick and precut to the length needed to span the gap between the two bond pads. The ribbon is attached to the bond pads by a thermal bonding process in which the ribbon is picked up by a bonding head that places the ribbon in contact with the two bonding pads. The bonding head then applies force and an ultrasonic vibration to the ribbon at a temperature sufficient to cause the ribbon to be bonded to the underlying pads, which include a gold layer.

The bonding tool must hold the ribbon against the pad and apply a lateral vibrating force at ultrasonic frequencies. Ideally, the ultrasonic vibration causes the ribbon to move relative to the bond pad thereby “scrubbing” the surfaces of both the ribbon and the bonding pad. However, the bonding tool can also move relative to the upper surface of the ribbon if the frictional forces between the bonding tool and the ribbon are of the same magnitude as the frictional forces between the ribbon and the bond pad. Movement of the bonding tool relative to the upper surface of the ribbon does not provide the necessary bonding motion and wastes energy.

In an attempt to prevent movement of the bonding tool relative to the upper surface of the ribbon, the bonding tool is often provided with a slightly roughened surface in the areas in which the tool contacts the ribbon. This “matte” finish increases the friction between the top surface of the ribbon and the surface of the bonding tool to reduce the relative motion of the bonding tool and the top surface of the ribbon. In practice, the matte finish is worn off of the bonding tool surface in a relatively short period of time, i.e., in 100 bonding operations. This short lifetime increases the cost of the bonding operation.

In addition, even with this matte finish, there is considerable movement between the bonding tool and the ribbon. This back and forth slippage at the ultrasonic frequency leads to wasted energy and reduces the reproducibility of the bonding operation since the degree of slippage changes over the life of the tool and varies with any change in the bonding pressure.

Finally, the quality of the bonds obtained with this type of matte finished tool is less than ideal. For example, the bonded ribbon is easily lifted off during a pull test. In addition, even in those cases in which the bonding parts meet visual inspection criteria, the bonds have a tendency to fail.

### SUMMARY OF THE INVENTION

The present invention includes an improved bonding tool for bonding a ribbon characterized by a thickness, to a bonding pad and the method for using the same. The bonding tool includes a transducer and a bond foot having a plurality of protrusions extending therefrom for pressing the ribbon against the bonding pad, the protrusions having a height greater than 40 percent of the ribbon thickness. The transducer causes the bond foot to move in a predetermined pattern with respect to the bond pad while the bond foot is pressed against the ribbon. In one embodiment, the height of the protrusions is between 40 and 80 percent of the ribbon thickness. In one embodiment, the protrusions include truncated pyramids having rectangular cross-sections. In one embodiment, the bond foot is characterized by a foot area; the protrusions contact the ribbon over a protrusion area, and the protrusion area is between 20 and 60 percent of the foot area. In one embodiment, the transducer causes said bond foot to move back and forth in a predetermined direction and said protrusions are aligned such that two sides of said protrusions are perpendicular to said predetermined direction.

### BRIEF DESCRIPTION OF THE DRAWINGS

FIG. 1 illustrates a ribbon bond between two pads.

FIG. 2 is a side view of the ribbon and pads during the bonding process.

FIG. 3 is a bottom view of a bond foot according to one embodiment of the present invention.

FIG. 4 is a cross-sectional view of the bond foot through line 4-4 shown in FIG. 3.

FIG. 5 is a cross-sectional view of a bond foot, ribbon, and a bonding pad during a bonding operation.

FIG. 6 is a cross-sectional view through one of the protrusions included in a bond foot.

FIG. 7 is a cross-sectional view of a bonding foot and ribbon when the bonding foot is at its maximum penetration into the ribbon.

### DETAILED DESCRIPTION OF PREFERRED EMBODIMENTS OF THE INVENTION

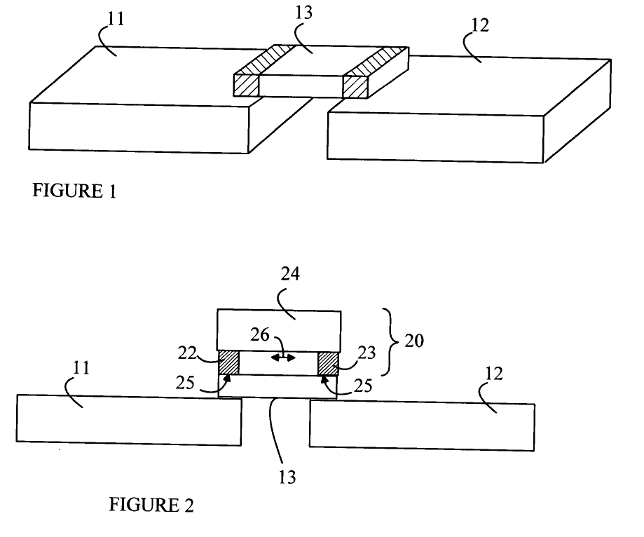

The manner in which the present invention provides its advantages can be more easily understood with reference to FIGS. 1 and 2. FIG. 1 illustrates a ribbon bond between two pads. In this simple example, ribbon 13 is connected between pads 11 and 12. FIG. 2 is a side view of the ribbon and pads during the bonding process. Ribbon 13 is held against pads 11 and 12 by a bonding tool 20 having an ultrasonic transducer 24 in contact with two bond feet shown at 22 and 23. Transducer 24 causes the bond feet to move back and forth in the direction shown by arrow 26. As noted above, ideally, the motion generated by transducer 24 causes ribbon 13 to move back and forth on the surface of pads 11 and 12 when bonding tool 20 is pressed against the ribbon. To this end, prior art bonding tools include a matte finish on the ends of the bond feet as shown at 25 to increase the friction between the bond feet and the top surface of ribbon 13, thereby reducing any slippage between the bond feet and ribbon 13. As noted above, this solution is less than perfect. The example shown in FIGS. 1 and 2 utilizes a bonding tool with two feet that contact the ribbon simultaneously. However, arrangements in which a bonding tool that has only one bond foot can also be used. In this case, the ribbon is first bonded to one of the pads and then the bond tool is moved to the portion of the ribbon over the other pad and ribbon is then bonded to that pad.

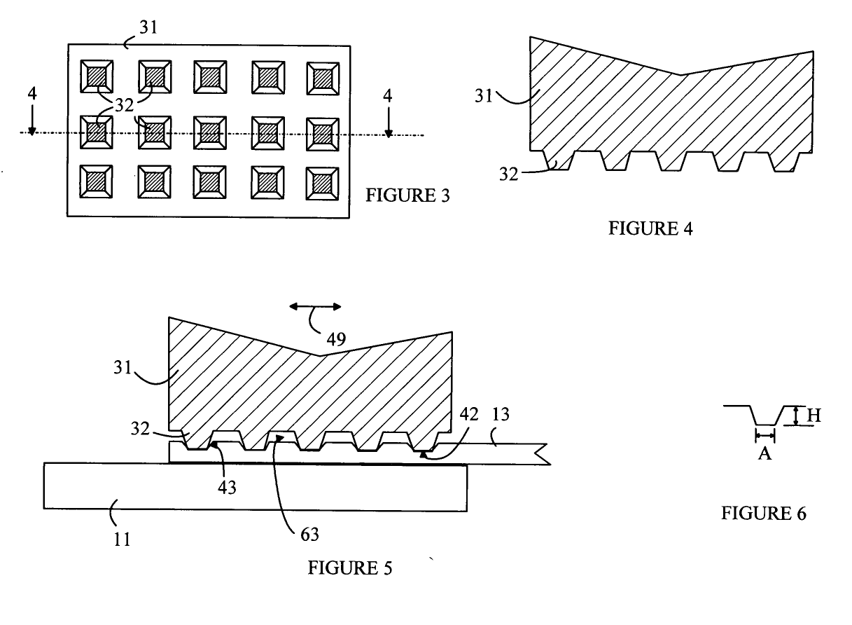

Refer now to FIGS. 3 and 4, which illustrate a transducer bond foot according to one embodiment of the present invention. FIG. 3 is a bottom view of bond foot 31, and FIG. 4 is a cross-sectional view of bond foot 31 through line 4-4. Bond foot 31 includes a plurality of protrusions 32 that extend from the bottom surface of bond foot 31 and engage ribbon 13 to reduce any slippage between bond foot 31 and ribbon 13. The size and spacing of the protrusions are chosen such that the protrusions deform ribbon 13 sufficiently to prevent slippage.

Refer now to FIG. 5, which is a cross-sectional view of bond foot 31, ribbon 13, and bonding pad 11 during a bonding operation. When bond foot 31 is pressed against ribbon 13 during the bonding process, the protrusions penetrate into ribbon 13 as shown at 42. These penetrations result in ridges such as ridge 43 that inhibit any lateral slippage between bond foot 31 and ribbon 13 when bond foot 31 is subjected to ultrasonic vibration.

Refer now to FIG. 6, which is a cross-sectional view through one of the protrusions discussed above. Each protrusion can be characterized by the area, A, of the end of the protrusion that contacts the ribbon and by the distance, H, by which the protrusion extends from the face of the bond foot. The contact area must be chosen such that the area is small enough to cause the surface of the ribbon to deform under the pressure applied during bonding. The distance H must be chosen such that the protrusions do not penetrate the ribbon to a depth that would significantly alter the physical integrity of the ribbon.

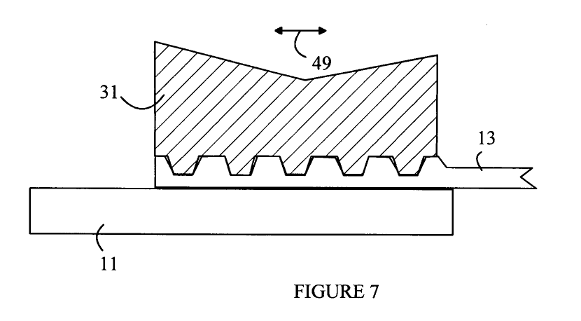

In general, A and H will depend on the force with which the bonding tool is pressed against the ribbon, the number of protrusions, and the material from which the ribbon is constructed. It should be noted that the face of the bond foot provides a stop that sets the maximum depth to which the protrusions can penetrate the ribbon. Hence, the protrusions will penetrate to the face so long as the force applied is above some minimum force that depends on the material, A, and the number of protrusions. Once that force is applied, the protrusions will penetrate the ribbon a distance H, and the material displaced will be extruded into the region between the protrusions. If the force on the bonding foot is sufficient, the spaces shown at 63 in FIG. 5 will be filled with the extruded material from the ribbon as shown in FIG. 7, which is a cross-sectional view of the bonding tool and ribbon when the bonding tool is at its greatest penetration into the ribbon. Once the region between the protrusions is filled, the pressure needed to penetrate the ribbon further increases significantly, and hence, further penetration is prevented.

When the bond foot is moved laterally by the ultrasonic transducer, the force is transferred to the ribbon by the protrusions along the ridge formed by the penetration of the protrusions into the ribbon. If A is too small, the pressure on the ribbon generated by the movement of the protrusion may exceed the pressure at which the ribbon tears. In one embodiment of the present invention, the transducer generates a back and forth motion in a single direction as shown by arrow 49 in FIG. 5. In this embodiment, the protrusions preferably have a rectangular tip with two sides of the rectangles perpendicular to the direction of motion. This arrangement spreads the force of the transducer motion uniformly over the ridges 43 created by the protrusion in the ribbon and reduces the danger of tearing the ribbon.

In one embodiment of the present invention, the bonding tool incorporates truncated pyramids on the bond foot that provide both improved ribbon bonding and ribbon pickup. In this embodiment, each protrusion is a truncated pyramid. Each protrusion has a height of 0.5 mils and a square cross-section having a side of 1 mil. The protrusions are arranged into two rows in parallel matrix form with every row having 6 pyramids. The pyramids are separated from one another by a distance of 0.80 mils in each row. A distance of 0.80 mils likewise separates the rows. The grooves between the pyramids have a matte finish in this embodiment.

In prior art bonding tools, the ribbon pickup depends solely on the matte finish on the bonding foot. As a result, ribbons are not always reliably transferred from the reservoir in which the ribbons reside to the bond pads being joined. In contrast, the built in pyramids on the bond foot in the present invention work as a set of “teeth” that firmly grip the ribbon to improve sticking of the ribbon to the bond foot. When the bond foot is pressed against a ribbon that is to be picked up by the bonding tool, the ribbon surface is deformed by the pyramids, and small indentation marks are created. Once the pyramids fully penetrate the ribbon, the ribbon is “locked” and held firmly by the bond foot. As noted above, this locking action also substantially reduces ribbon slippage along the scrubbing direction during ultrasonic vibration of the ribbon against the bonding pad. Accordingly, the ultrasonic energy is concentrated in the micro-welding process.

The above-described embodiments utilized a particular height for the protrusions. If the height is too small, the depth of penetration of the protrusions into the ribbon will be too small and slippage can occur between the top surface of the ribbon and the bond foot, leading to the various problems discussed above. If the height is too large, the amount of material between the protrusion and the bond pad after the protrusions have fully penetrated the ribbon will be insufficient to provide a good bond. In addition, the ribbon may tear during the ultrasonic welding process. In the embodiments described above, the protrusion height was set to half of the ribbon thickness. However, the present invention provides a significant improvement with protrusion heights that are between 40 and 80 percent of the ribbon thickness.

Likewise, the fraction of the area of the bond foot that is occupied by the protrusions can be adjusted to provide optimum bonding. The area of the ribbon that is pressed against the pond pad by the protrusions determines the fraction of the area of the ribbon that is subjected to the scrubbing motion of the ultrasonic welding process. If the area is too small, the ribbon will be welded at discrete points with the areas in between these points having a lower bond strength. If, one the other hand, the area is too large, the protrusions will not penetrate the ribbon fully when the bond foot is pressed against the ribbon during the bonding process. In practice, the protrusions can occupy an area between 20 and 60 percent of the bond foot area and still provide a significant improvement over prior art bond foot designs.

As noted above, the present invention provides a number of advantages over prior art bonding tools. In particular, protrusions substantially reduce ribbon slippage relative to the bonding head and improve ribbon bond strength. In addition, the use of high wear resistance material to fabricate the bonding foot greatly improves the tool lifetime relative to matte finish bonding tools, and hence, reduces the manufacturing cost of the ribbon bonding process.

Furthermore, the examination of the bonds to determine if the bond is “good” or “bad” is significantly simplified using the bonding tool of the present invention. It has been found that so long as the ribbon has not been damaged and there are no black spots in the protrusion impressions, the bond is “good”.

The above-described embodiments of the present invention utilize a particular shape of protrusion on the bonding foot, namely a truncated pyramid. However, other bonding foot shapes can be utilized. For example, a protrusion in the shape of a truncated cone could be utilized. In addition, the protrusions need not be truncated.

Various modifications to the present invention will become apparent to those skilled in the art from the foregoing description and accompanying drawings. Accordingly, the present invention is to be limited solely by the scope of the following claims.

1. A bonding tool for bonding a ribbon characterized by a thickness, to a bonding pad, said bonding tool comprising:
a bond foot having a plurality of protrusions extending therefrom for pressing said ribbon against said bonding pad, said protrusions having a height greater than 40 percent of said ribbon thickness;
a transducer for causing said bond foot to move in a predetermined pattern with respect to said bond pad while said bond foot is pressed against said ribbon.

2. The bonding tool of claim 1 wherein said height of said protrusions is between 40 and 80 percent of said thickness of said ribbon.

3. The bonding tool of claim 1 wherein said protrusions have a rectangular cross-section.

4. The bonding tool of claim 3 wherein said protrusions comprise truncated pyramids having a top surface parallel to a surface of said ribbon said protrusions all having the same height.

5. The bonding tool of claim 3 wherein said transducer causes said bond foot to move back and forth in a predetermined direction and wherein two sides of said rectangular cross-section of said protrusions are perpendicular to said predetermined direction.

6. The bonding tool of claim 1 wherein said bond foot is characterized by a foot area, wherein said protrusions contact said ribbon over a protrusion area, and wherein said protrusion area is between 20 and 60 percent of said foot area.

7. A method for bonding a ribbon characterized by a thickness, to a bonding pad, said method comprising:
placing said ribbon between said pad and a bonding tool having a bond foot comprising a plurality of protrusions extending therefrom for pressing said ribbon against said bonding pad, said protrusions having a height greater than 40 percent of said ribbon thickness, and
causing said bond foot to move in a predetermined pattern with respect to said bond pad while said bond foot is pressed against said ribbon.

8. The method of claim 7 wherein said height of said protrusions is between 40 and 80 percent of said thickness of said ribbon.

9. The method of claim 7 wherein said protrusions have a rectangular cross-section.

10. The method of claim 9 wherein said protrusions comprise truncated pyramids.

11. The bonding tool of claim 9 wherein said bond foot moves back and forth in a predetermined direction and wherein two sides of said rectangular cross-section of said protrusions are perpendicular to said predetermined direction.

12. The method of claim 7 wherein said bond foot is characterized by a foot area, wherein said protrusions contact said ribbon over a protrusion area, and wherein said protrusion area is between 20 and 60 percent of said foot area,
